(19) United States
(12) Patent Application Publication
(10) Pub. No.: US 2026/0016575 A1
(43) Pub. Date: Jan. 15, 2026

(54) OPTICAL DEVICE FOR TRACKING THE POSITION OF AN OBJECT

(71) Applicant: COMMISSARIAT A L'ÉNERGIE ATOMIQUE ET AUX ENERGIES ALTERNATIVES, Paris (FR)

(72) Inventors: Bastien CHAMPEAU, Is-Sur-Tille (FR); Etienne PATAILLE, Is-Sur-Tille (FR)

(73) Assignee: COMMISSARIAT A L'ÉNERGIE ATOMIQUE ET AUX ENERGIES ALTERNATIVES, Paris (FR)

(21) Appl. No.: 19/265,038

(22) Filed: Jul. 10, 2025

(30) Foreign Application Priority Data
Jul. 12, 2024 (FR) FR2407691

(51) Int. Cl. G01S 7/481; G01S 17/50

(52) U.S. Cl. CPC G01S 7/4817; G01S 17/50

(57) ABSTRACT

Device for determining a position of an object, the object comprising a target retroreflector, comprising:

a laser emitter configured for emitting an incident laser beam towards the target retroreflector;

a detector, configured for detecting a laser beam reflected by the target retroreflector;

a centring unit, configured for adjusting a position of the laser emitter as a function of the detected laser beam;

the device being characterized in that:

the device comprises a mirror, configured for reflecting the incident laser beam towards the target retroreflector;

the device comprises a processing unit configured for determining a real position of the target retroreflector, as a function of the position and of the orientation of the mirror, and of the virtual position of the target retroreflector, after the incident laser beam has been centred with respect to the target retroreflector.

### TECHNICAL FIELD

The technical field of the invention is optical metrology and, more precisely, laser tracking.

### PRIOR ART

A laser tracker is a high precision laser tracking device used for following and for measuring with a high precision the position of objects in three dimensions. These devices are used in numerous industrial fields, for example, and in a non-limiting manner, the aerospace, automobile, and ship building industries.

A laser tracker is composed of a laser mounted on two perpendicular axes of rotation, motorized and equipped with angular encoders. The object whose position is measured or tracked by the laser, and hereinafter denoted the target, is connected to a retroreflector. The retroreflector is composed of three mirrors, forming a corner of a cube, mounted for example in a sphere. The cube corner is positioned at the centre of the sphere. This type of retroreflector is denoted “SMR: Spherically Mounted Reflector”. The laser tracker is notably capable of dynamically following the movements of the measurement point corresponding to the centre of the retroreflector.

By virtue of two closed-loop controlled motors, mounted on the two axes of rotation, the laser tracker can point its beam in all directions. The closed-loop controls of the two motors allow the beam to be permanently directed at the centre of the retroreflector. For this purpose, a part of the reflected beam is directed towards a detector. The resulting signal from the detector serves as a setpoint for the closed-loop controls so as to keep the beam centred on the retroreflector.

FIGS. 1A and 1B show schematically a device for positioning a target according to the prior art. The device comprises:
a laser emitter 10, configured for emitting an incident laser beam towards a retroreflector 21 of the SMR type, mounted on an object 20 to be controlled;
a detector 11, configured for detecting the laser beam reflected by the target;
a camera 12, allowing a fast detection for retroreflectors of the SMR type
a support 13, rotationally mobile, designed to adjust a position and an orientation of the laser emitter and of the detector;
a centring unit 14, configured for analysing the signal detected by the detector, and for closed-loop controlling the position and the orientation of the support as a function of the resulting signal from the detector.

One of the constraints for the use of a laser tracker is that the object to be controlled must be in direct line-of-sight of the laser, with no screen interposed between the tracker and the target. However, the object to be controlled may be situated in a cluttered area, not allowing the tracker to be disposed or difficult to access for a person.

The object to be controlled may also be disposed in an area whose environment is not very conducive to a laser tracker: unsuitable temperature and/or humidity, or high levels of radiation, or the presence of a magnetic or electric field able to interfere with the laser tracker.

Under the conditions listed in the preceding paragraph, the laser tracker must be far away from the object to be measured, with a potential presence of obstacles, for example protection screens or walls, between the laser and the object to be controlled. The latter is no longer in direct line-of-sight of the laser.

Patent EP1171752 addresses this problem and provides for a rigid support, comprising a retroreflector able to be placed remotely from an object to be controlled.

The position of the object may be determined indirectly by knowing the remote position of the retroreflector with respect to the object. However, this assumes the presence of a support on the object, and potentially the moving of support on the surface of the object, which may pose operational constraints.

Patent CN103499293 describes a method allowing the precision of a laser tracker to be improved by the use of mirrors disposed around an object to be controlled. The mirrors are configured for directing the laser beam, emitted by the laser tracker, onto the same point of the object. Seen from the object, each image allows a virtual image of the tracker to be formed. The objective is to take advantage of the redundancy of the measurements performed by directing the laser beam onto four mirrors, so as to obtain as many measurements as mirrors. The four mirrors define four different optical paths between the tracker and the object to be controlled.

The inventors provide a laser tracking device able to be implemented remotely from an object to be controlled, in the absence of a direct line-of-sight between the laser emitter and the object.

### DESCRIPTION OF THE INVENTION

A first aspect of the invention is a device for determining a position of an object, the object comprising a target retroreflector, the device comprising:
a laser emitter, rotationally mobile on a support, and configured for emitting an incident laser beam towards the target retroreflector;
a detector, configured for detecting a laser beam reflected by the target retroreflector illuminated by the incident beam;
a centring unit, configured for adjusting a position of the laser emitter as a function of the laser beam detected by the detector;

wherein:
the device comprises a mirror, comprising at least one auxiliary retroreflector, the mirror being configured for reflecting the incident laser beam towards the target retroreflector;
the centring unit is configured for
   closed-loop controlling a position of the support as a function of the laser beam reflected by the target retroreflector, then by the mirror, so as to direct the incident laser beam towards the target retroreflector;
   determining a virtual position of the target retroreflector, through the mirror;
the device comprises a processing unit configured for
   receiving or determining a position and orientation of the mirror;
   determining a real position of the target retroreflector, as a function of the position and of the orientation of the mirror, and of the virtual position of the target retroreflector, after the incident laser beam has been centred with respect to the target retroreflector.

According to one possibility:
the mirror is plane;
the mirror comprises two or three auxiliary retroreflectors, defining a plane of the mirror;
the processing unit is configured for
   centring the laser emitter successively with respect to each auxiliary retroreflector;
   then, determining the position and the orientation of the mirror based on each beam respectively reflected by each auxiliary retroreflector.

The device may comprise a camera, whose optical axis is parallel to an emission axis of the laser beam, the centring unit being configured for detecting a retroreflector on each image generated by the camera.

According to one possibility:
the mirror is mobile in rotation and/or in translation with respect to the laser emitter;
the device comprises a control unit, configured for controlling a rotation of the mirror as a function of a control signal generated by the processing unit.

The processing unit may be configured for controlling the control unit in such a manner that the target reflector is visible, by the camera, through the mirror.

The processing unit may be configured for controlling the control unit in such a manner that the target reflector is disposed within the field of observation of the camera, through the mirror.

Advantageously, the incident laser beam extends between the laser emitter and the target retroreflector along a single optical path. This means that there is only one beam propagating between the laser and the object.

The device may comprise several mirrors, in series, in such a manner that the beam is successively reflected by several mirrors up to the object.

A second aspect of the invention is a method for determining a position of an object, equipped with a target retroreflector, using a device according to the first aspect of the invention, the mirror being oriented in such a manner that the incident beam, emitted by the laser emitter, circumvents an obstacle extending between the object and the laser emitter, the method comprising the following steps:
a) closed-loop control of a position of the support as a function of the laser beam reflected by the target retroreflector, then by the mirror, so as to centre the incident laser beam with respect to the target retroreflector;
b) following the step a), determination of a position of the target retroreflector as a function of the orientation of the mirror.

Thus, the incident beam, emitted by the laser emitter, circumvents the obstacle before reaching the target retroreflector.

The mirror may comprise at least one auxiliary reflector or at least two auxiliary reflectors or at least three auxiliary retroreflectors, non-aligned, defining a plane of the mirror, the method comprising, prior to the step a):
successive centring of the laser emitter with respect to the or to each auxiliary retroreflector;
determination of a position and orientation of the mirror using each laser beam respectively reflected by each auxiliary retroreflector.

The mirror may be mobile in rotation and/or in translation with respect to the laser emitter, in which case the method may comprise, prior to the step a), a rotation and/or a translation of the mirror as a function of a control signal generated by the processing unit.

The rotation of the mirror may be effected so as to form an image of the target

reflector, through the mirror, by the camera.

The invention will be better understood by reading the exemplary embodiments presented, in the following part of the description, in relation with the figures listed hereinbelow.

### FIGURES

FIGS. 1A and 1B show a configuration of the prior art.

FIG. 2A shows a simplified view of a device according to the invention.

FIG. 2B shows a mirror forming part of the device according to the invention.

FIG. 3A shows schematically the reference frame of the tracker and the reference frame of the mirror.

FIGS. 3B to 3D illustrate successive rotations going from the reference frame of the mirror to the reference frame of the tracker.

FIG. 4A shows the main steps for positioning the target reflector by means of the tracker.

FIG. 4B shows the detail of the step 150 in FIG. 4A.

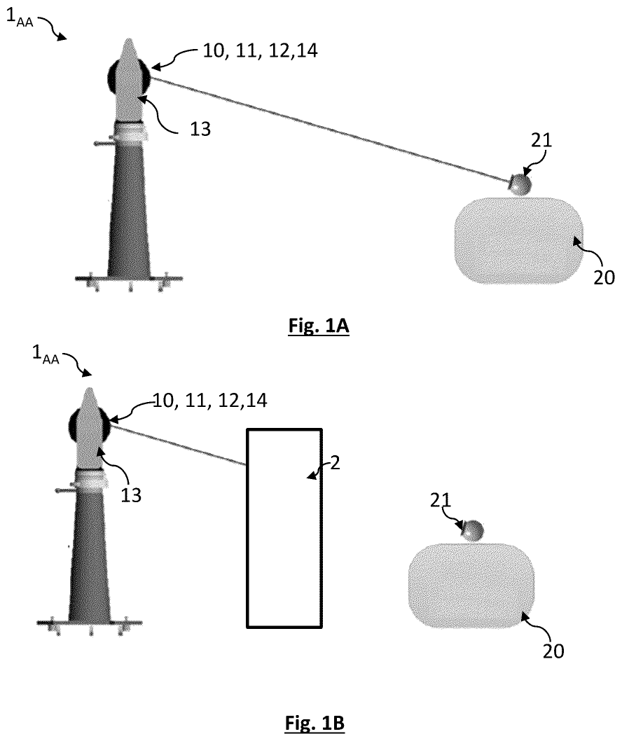

### DESCRIPTION OF PARTICULAR EMBODIMENTS

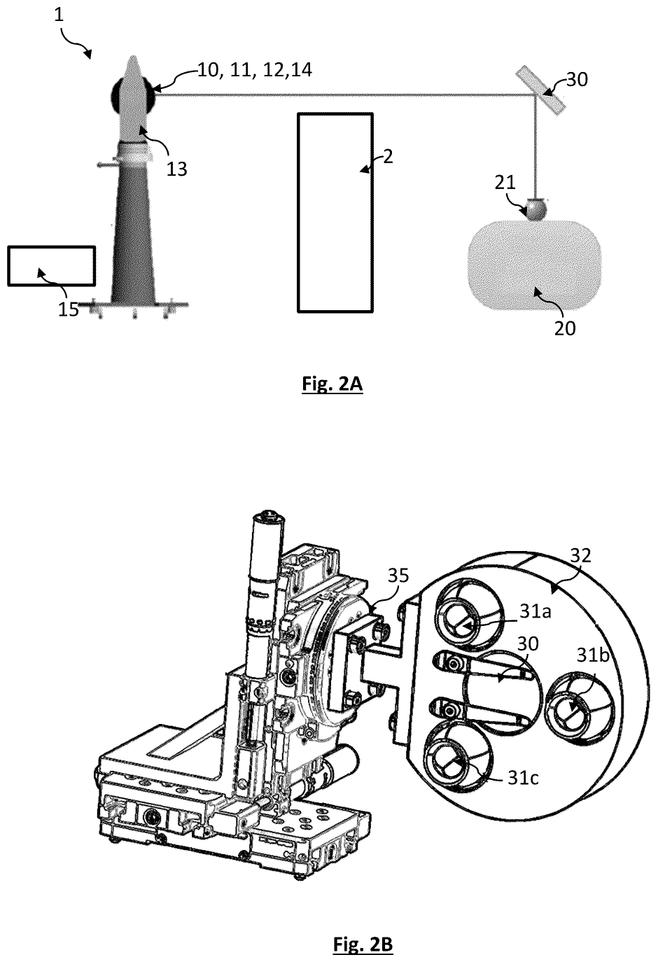

FIG. 2A shows a device 1 according to the invention. The device comprises the same components as described in relation with the prior art. The device comprises a mirror 30, arranged between the laser emitter 10 and the object 20 to be controlled. The object to be controlled is connected to a target retroreflector 21. The mirror 30 is configured for deviating the incident laser beam around an obstacle 2, the latter extending through a direct line-of-sight of the laser emitter. “Direct line-of-sight” is understood to mean a straight line extending between the laser emitter and the retroreflector connected to the object to be controlled. Thus, the mirror is arranged so as to establish an optical path circumventing the obstacle 2 extending between the object and the laser emitter.

In this example, the device comprises a detector 11, for example based on a PSD (Position Sensitive Device) cell which is a beam position detector. If the beam does not reach the retroreflector at the centre, then it doesn't reach the PSD cell at the centre either, thus creating an error signal. The error signal is representative of an offset between the direction of emission of the incident laser beam and the direction in which the incident beam is reflected by the target retroreflector disposed on the object.

The device preferably comprises a camera 12, configured for forming an image of the scene observed. The centring unit 14 is then programmed for localizing retroreflectors of the SMR type using the image of the camera. This allows a first positioning of each retroreflector, the more precise positioning being obtained by progressively moving the laser beam to the centre of the reflector.

The centring unit 14 also comprises encoders allowing the orientation of the laser beam, together with the distance travelled by the beam up to the retroreflector, to be recorded. The latter may be calculated by a conventional measurement of the time of flight of the laser beam between its emission and its detection by the detector 11.

The device comprises a processing unit 15, configured for carrying out processing steps described in the following text. The processing unit comprises for example a microprocessor.

FIG. 2B shows the mirror 30. The latter is carried by a chassis 32, comprising three auxiliary retroreflectors 31a, 31b and 31c, preferably non-aligned. Each auxiliary retroreflector may be of the same type as the target retroreflector 21 disposed on the object 20 being tracked. The mirror may be installed to be mobile in rotation and/or in translation, the rotation and/or the translation being controlled by a control unit 35.

The presence of three non-aligned retroreflectors is advantageous because it allows a determination, by measurement, of the position and of the orientation of the mirror, as described in the following text. According to another possibility, the mirror comprises one or two retroreflectors, which may require more information, for example prior information, for determining the position and the orientation of the mirror.

One important aspect of the invention is that the device is arranged in such a manner that the incident laser beam, emitted by the laser emitter 10, is reflected towards the object 20 by the mirror 30. In a symmetrical fashion, the mirror sends back, towards the detector 11, the beam reflected by the target retroreflector 21.

The centring unit 14 is programmed for closed-loop controlling the support 13 in such a manner that the reflected beam gets to the detector 11 being coaxial, or able to be considered as such, with the incident beam. The smaller the spatial offset between the incident beam and the reflected beam, the better the position of the target retroreflector 21 is controlled.

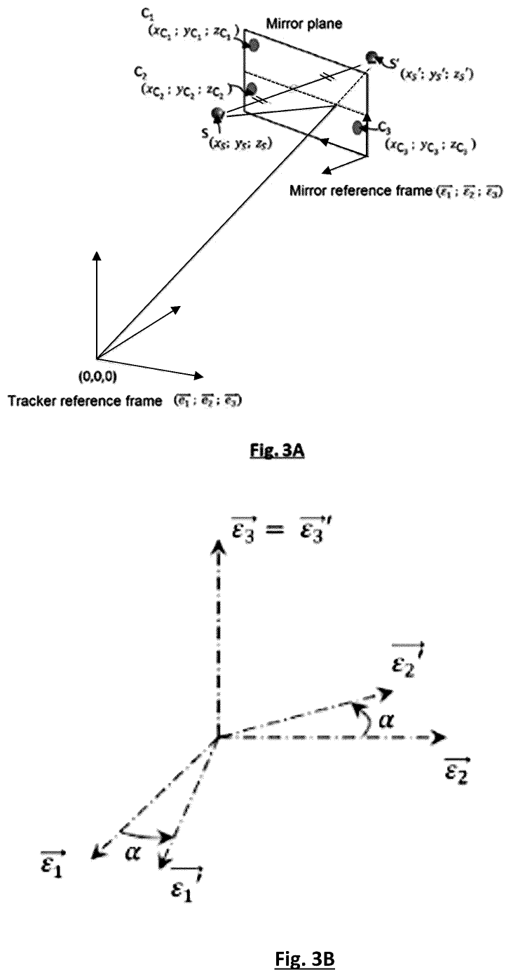

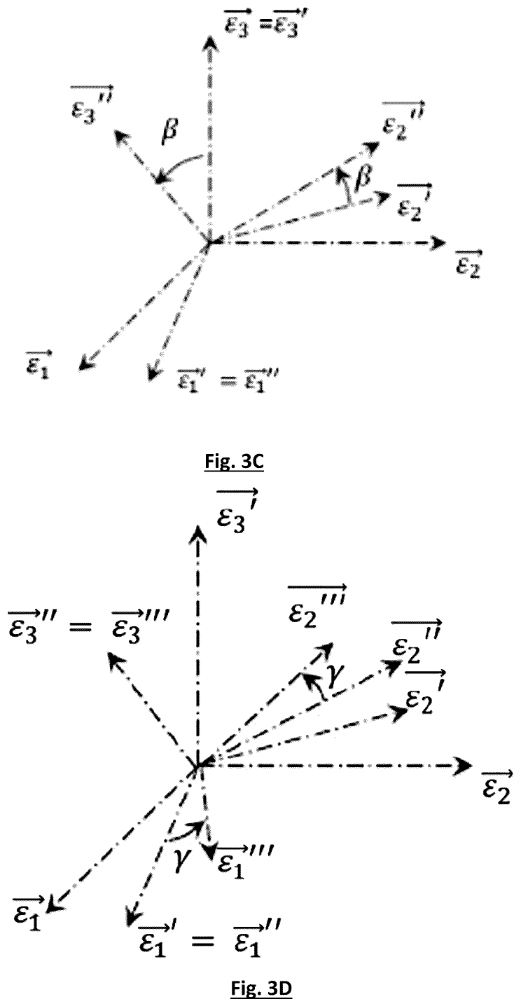

A reference frame of the device is now considered, defined by an orthonormal basis (\vec{e₁}, \vec{e₂}, \vec{e₃}), shown in FIG. 3A, centred on an origin point (0,0,0) fixed with respect to the support 13. The origin point and the orthonormal basis (\vec{e₁}, \vec{e₂}, \vec{e₃}) define a reference frame of the device R. An orthonormal basis (\vec{ε₁}, \vec{ε₂}, \vec{ε₃}) is assigned to the mirror 30, forming the reference frame of the mirror Rₘ.

The coordinates of the respective centres of the auxiliary retroreflectors 21₁, 21₂ and 21₃ are denoted by C₁, C₂ and C₃. If n is the vector normal to the plane of the mirror,

$$\vec{n} = \vec{{C}_{1} {C}_{2}} ⋀ \vec{{C}_{1} {C}_{3}} \qquad ( 1 )$$

The cartesian equation of the plane of the mirror is:

$$ax + by + cz + d = 0 , \qquad ( 2 )$$

a, b, c and d being scalars, x, y and z being coordinates in the reference frame of the device.

With

$$\vec{n} = ( \begin{matrix}a \\ b \\ c\end{matrix} ) \qquad ( 3 )$$

d may be obtained by applying (2) to the coordinates of each point C₁, C₂ and C₃, the latter being obtained by pointing the laser emitter successively at the centre of each auxiliary retroreflector.

Each vector \vec{ε₁}, \vec{ε₂}, and \vec{ε₃} may be such that:

$$\vec{{ε}_{1}} = \vec{{C}_{2} {C}_{2}} \qquad ( 4 )$$

$$\vec{{ε}_{2}} = \vec{{C}_{1} {C}_{4}} , with \vec{{C}_{1} {C}_{4}} = \vec{n} ⋀ \vec{{C}_{1} {C}_{2}} \qquad ( 5 )$$

$$\vec{{ε}_{3}} = \vec{n} \qquad ( 6 )$$

FIG. 3A shows the coordinates of the real point S and of its image S′ (or virtual object) by the mirror, the point S corresponding to the centre of the target. The real point S corresponds to the centre of the target reflector 21.

The laser tracker allows the coordinates of the virtual point S′ to be obtained, in the reference frame of the device. The following measurement is thus obtained

$${( \begin{matrix}{x}_{{s}^{′}} \\ {y}_{{s}^{′}} \\ {z}_{{s}^{′}}\end{matrix} )}_{( \vec{{e}_{1}} , \vec{{e}_{2}} , \vec{{e}_{3}} )}$$

However, the coordinates of S in the reference frame of the device are sought; i.e.

$${( \begin{matrix}{x}_{s} \\ {y}_{s} \\ {z}_{s}\end{matrix} )}_{( \vec{{e}_{1}} , \vec{{e}_{2}} , \vec{{e}_{3}} )}$$

In the reference frame of the mirror:

$${( \begin{matrix}{x}_{s} \\ {y}_{s} \\ {z}_{s}\end{matrix} )}_{( \vec{{ε}_{1}} , \vec{{ε}_{2}} , \vec{{ε}_{3}} )} = {( \begin{matrix}{x}_{{s}^{′}} \\ {y}_{{s}^{′}} \\ {z}_{{s}^{′}}\end{matrix} )}_{( \vec{{ε}_{1}} , \vec{{ε}_{2}} , \vec{{ε}_{3}} )} \times ( \begin{matrix}1 & 0 & 0 \\ 0 & 1 & 0 \\ 0 & 0 & - 1\end{matrix} ) \qquad ( 7 )$$

The coordinates of each vector \vec{ε₁}, \vec{ε₂}, and \vec{ε₃} are expressed, in the basis (\vec{e₁}, \vec{e₂}, \vec{e₃}), as follows:

$$\vec{{ε}_{1}} = u \vec{{e}_{1}} + v \vec{{e}_{2}} + w \vec{{e}_{3}} \qquad ( 8 )$$

$$\vec{{ε}_{2}} = {u}^{′} \vec{{e}_{1}} + {v}^{′} \vec{{e}_{2}} + {w}^{′} \vec{{e}_{3}} \qquad ( 9 )$$

$$\vec{{ε}_{3}} = {u}^{″} \vec{{e}_{1}} + {v}^{″} \vec{{e}_{2}} + {w}^{″} \vec{{e}_{3}} \qquad ( 10 )$$

A transition matrix may be formed

$$P = [ \begin{matrix}u & v & w \\ {u}^{′} & {v}^{′} & {w}^{′} \\ {u}^{″} & {v}^{″} & {w}^{″}\end{matrix} ] \qquad ( 11 )$$

The transition between the reference frames (\vec{e₁}, \vec{e₂}, \vec{e₃}) and (\vec{ε₁}, \vec{ε₂}, \vec{ε₃}) may be written:

$$( \vec{{e}_{1}} , \vec{{e}_{2}} , \vec{{e}_{3}} ) = ( \vec{{ε}_{1}} , \vec{{ε}_{2}} , \vec{{ε}_{3}} ) {P}^{- 1} \qquad ( 12 )$$

$$With {P}^{- 1} = \frac{1}{det ( P )} \times Adj ( P ) \qquad ( 13 )$$

det(P) is the determinant of P
Adj (P) is the adjugate of P

Three rotation matrices may be defined respectively according to the Euler angles: α (precession angle), β (nutation angle) and γ (rotation angle proper) defined respectively in FIGS. 3B, 3C and 3D. The angles α, β and γ are calculated by the processing unit 15 based on the coordinates of the points C₁, C₂ and C₃.

FIG. 3B shows the precession angle a (or first Euler angle), according to which a change of reference frame is carried out between the reference frame Rₘ (\vec{ε₁}, \vec{ε₂}, \vec{ε₃}) and a first intermediate reference frame Rₘ₁ (\vec{ε₁′}, \vec{ε₂′}, \vec{ε₃′}) with \vec{ε₃′}=\vec{ε₃}. The transition from the reference frame Rₘ to the reference frame Rₘ₁ is carried out by a rotation R{right arrow over (_{ε}_{_{3,}})}_{α}, through the angle α, around the axis \vec{ε₃}:

$${R}_{\vec{{ε}_{3}} , α} = [ \begin{matrix}cos α & - sin α & 0 \\ sin α & cos α & 0 \\ 0 & 0 & {1}^{″}\end{matrix} ] \qquad ( 14 )$$

FIG. 3C shows the nutation angle β (or second Euler angle), according to which a change of reference frame is carried out between the first intermediate reference frame Rₘ₁ (\vec{ε₁′}, \vec{ε₂′}, \vec{ε₃′}) and a second intermediate reference frame Rₘ₂ (\vec{ε₁″}, \vec{ε₂″}, \vec{ε₃′}) with \vec{ε₁″}−\vec{ε₁′}. The transition from the reference frame Rₘ₁ to the reference frame Rₘ₂ is carried out by a rotation R\vec{_{ε}_{₁}_{′}}_{,β}, through the angle β, around the axis \vec{ε_{1′}}:

$${R}_{\vec{{ε}_{{1}^{′}}} , β} = [ \begin{matrix}cos β & 0 & sin β \\ 0 & 1 & 0 \\ - sin β & 0 & cos β\end{matrix} ] \qquad ( 15 )$$

FIG. 3D shows the rotation angle proper γ (or third Euler angle), according to which a change of reference frame is carried out between the second intermediate reference frame Rₘ₂ (\vec{ε₁″}, \vec{ε₂″}, \vec{ε₃″}) and a third intermediate reference frame Rₘ₃ (\vec{ε₁′″}, \vec{ε₂′″}, \vec{ε₃′″}) with \vec{ε₃′″}−\vec{ε₃″}. The transition from the reference frame Rₘ₂ to the reference frame Rₘ₃ is carried out by a rotation R{right arrow over (_{ε}_{_{3″}})}_{,γ}, through the angle γ, around the axis \vec{ε₃″}:

$${R}_{\vec{{ε}_{3 ″}} , γ} = [ \begin{matrix}1 & 0 & 0 \\ 0 & cos γ & - sin γ \\ 0 & sin γ & cos γ\end{matrix} ] \qquad ( 16 )$$

A rotation matrix R is deduced from the above, formed of a matrix product of the three matrices defined in (14) to (16).

$$R = {R}_{\vec{{ε}_{3}} , α} \times {R}_{\vec{{ε}_{{1}^{′}}} , β} \times {R}_{\vec{{ε}_{{3}^{″}}} , γ} \qquad ( 17 )$$

The basis (\vec{ε₁′″}, \vec{ε₂′″}, \vec{ε₃′″}) of the third intermediate reference frame is parallel to the basis (\vec{e₁}, \vec{e₂}, \vec{e₃}) and centred on the origin of the reference frame of the mirror (\vec{ε₁}, \vec{ε₂}, \vec{ε₃}) The term “parallel basis” corresponds to the fact that the vectors \vec{ε₁′″}, \vec{ε₂′″}, \vec{ε₃′″} are respectively parallel to the vectors \vec{e₁}, \vec{e₂}, \vec{e₃}. The third intermediate reference frame Rₘ₃ goes to the reference frame of the tracker by a translation \vec{T} between the origin of the reference frame of the laser tracker and the origin 0′ of the reference frame of the mirror, where the origin 0′ may be one of the retroreflectors.

$$\vec{T} = ( \begin{matrix}{x}_{{0}^{′}} \\ {y}_{{0}^{′}} \\ {z}_{{0}^{′}}\end{matrix} ) \qquad ( 18 )$$

The coordinates of the centre S of the target reflector 21 in the reference frame of the device is thus obtained starting from the coordinates in the reference frame of the mirror by the expression:

$${( \begin{matrix}{x}_{s} \\ {y}_{s} \\ {z}_{s}\end{matrix} )}_{( \vec{{e}_{1}} , \vec{{e}_{2}} , \vec{{e}_{3}} )} = {( \begin{matrix}{x}_{s} \\ {y}_{s} \\ {z}_{s}\end{matrix} )}_{( \vec{{ε}_{1}} , \vec{{ε}_{2}} , \vec{{ε}_{3}} )} \times R + \vec{T} \qquad ( 20 )$$

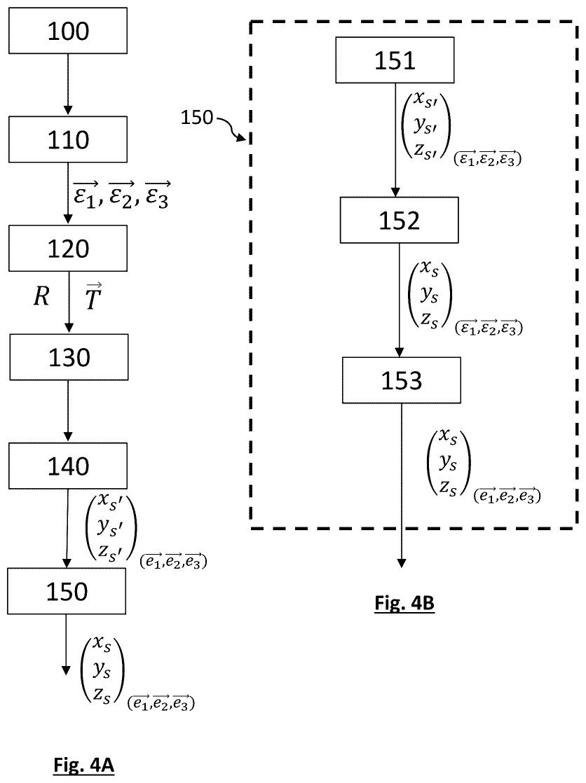

FIG. 4A describes the main steps for implementing a device according to the invention.
Step 100: verification of the line-of-sight of the tracker

During this step, it is ensured that the target retroreflector 21 is indeed in the observation field of the tracker, through the mirror 30. This step may be carried out by implementing the camera of the tracker: it is assumed that the observation field of the camera is similar to the observation field of the tracker. According to one possibility, depending on the position of the target retroreflector detected by the camera 12, the control unit 35 of the mirror 30 is activated, so as to dispose the target retroreflector 21 in a central part of the mirror seen by the tracker. The control unit 35 is then controlled by a control signal generated by the processing unit 15.

Once the retroreflector is in the field of the tracker, the tracker is configured for directing the laser beam at the centre of the target retroreflector, and for orienting itself in such a manner that the laser is maintained, by the centring unit 14, at the centre of the retroreflector by “auto-lock”.
Step 110: taking into account the position and the orientation of the mirror

This involves defining the vectors \vec{ε₁}, \vec{ε₂}, \vec{ε₃} of the reference frame associated with the mirror.

The orientation of the mirror may be fixed and predefined in which case the vectors \vec{ε₁}, \vec{ε₂}, \vec{ε₃} are pre-loaded into the processing unit 15. If this is not the case, the vectors \vec{ε₁}, \vec{ε₂}, \vec{ε₃} are determined experimentally, by directing the tracker towards each auxiliary retroreflector and by successively defining the points C₁, C₂ and C₃. For this purpose, the camera 12 is implemented in such a manner as to detect each auxiliary retroreflector and direct the laser beam successively towards each auxiliary retroreflector. The precise position of the centre of each auxiliary retroreflector is defined by the laser tracker closed-loop controlled by the centring unit 14.
Step 120: determination of the transition matrix and of the translation vector.

As a function of the vectors \vec{ε₁}, \vec{ε₂}, \vec{ε₃}, the processing unit 15 calculates the transition matrix R and the translation vector \vec{T} such as laid out in (14) to (20).
Step 130: localization of the target retroreflector 21 through the mirror 30. During this step, the laser beam is directed towards the mirror. Then, the laser emitter is closed-loop controlled by the centring unit 14 in such a manner as to lock onto the position of the centre of the target retroreflector 21.
Step 140: determination of the virtual coordinates of the target retroreflector, in the reference frame of the device: these are the coordinates

$${( \begin{matrix}{x}_{s}^{′} \\ {y}_{s}^{′} \\ {z}_{s}^{′}\end{matrix} )}_{( \vec{{e}_{1}} , \vec{{e}_{2}} , \vec{{e}_{3}} )}$$

cf. FIG. 3A.

This step is implemented by the centring unit 14. It may also be implemented by the processing unit 15.
Step 150: determination of the real coordinates

$${( \begin{matrix}{x}_{s} \\ {y}_{s} \\ {z}_{s}\end{matrix} )}_{( \vec{{e}_{1}} , \vec{{e}_{2}} , \vec{{e}_{3}} )}$$

of the target retroreflector, in the reference frame of the device. This step is implemented by the processing unit 15.

This step may comprise the following sub-steps, shown in FIG. 4B:
Sub-step 151: determination of the coordinates of the virtual point S′ in the reference frame of the mirror: the following relationship is applied

$${( \begin{matrix}{x}_{s ′} \\ {y}_{s ′} \\ {z}_{s ′}\end{matrix} )}_{( \vec{{ε}_{1}} , \vec{{ε}_{2}} , \vec{{ε}_{3}} )} = ( {( \begin{matrix}{x}_{s ′} \\ {y}_{s ′} \\ {z}_{s ′}\end{matrix} )}_{( \vec{{e}_{1}} , \vec{{e}_{2}} , \vec{{e}_{3}} )} - \vec{T} ) \times {R}^{- 1}$$

R⁻¹ may be determined, starting from R, according to (13)
Sub-step 152: determination of the coordinates of the point S in the reference frame of the mirror: the relationship (7) is applied, in such a manner as to obtain

$${( \begin{matrix}{x}_{s} \\ {y}_{s} \\ {z}_{s}\end{matrix} )}_{( \vec{{ε}_{1}} , \vec{{ε}_{2}} , \vec{{ε}_{3}} )}$$

starting from

$${( \begin{matrix}{x}_{s ′} \\ {y}_{s ′} \\ {z}_{s ′}\end{matrix} )}_{( \vec{{ε}_{1}} , \vec{{ε}_{2}} , \vec{{ε}_{3}} )}$$

Sub-step 153: determination of the coordinates of S in the reference frame of the device, by applying (20) using

$${( \begin{matrix}{x}_{s} \\ {y}_{s} \\ {z}_{s}\end{matrix} )}_{( \vec{{ε}_{1}} , \vec{{ε}_{2}} , \vec{{ε}_{3}} )}$$

in order to obtain

$${( \begin{matrix}{x}_{s} \\ {y}_{s} \\ {z}_{s}\end{matrix} )}_{( \vec{{e}_{1}} , \vec{{e}_{2}} , \vec{{e}_{3}} )}$$

The invention will be able to be implemented while the object to be detected is disposed in an area where the access conditions are difficult, in particular owing to the cluttered environment, or whose environmental conditions (temperature, humidity, irradiation) do not allow the tracker to be disposed directly facing the object to be controlled.

1. A device for determining a position of an object, the object comprising a target retroreflector, the device comprising:
a laser emitter, rotationally mobile on a support, and configured for emitting an incident laser beam towards the target retroreflector;
a detector, configured for detecting a laser beam reflected by the target retroreflector illuminated by the incident beam;
a centring unit, configured for adjusting a position of the laser emitter based on the laser beam detected by the detector;
wherein:
the device comprises a mirror, comprising at least one auxiliary retroreflector, the mirror being configured for reflecting the incident laser beam towards the target retroreflector;
the centring unit is configured for
closed-loop controlling a position of the support based on the laser beam reflected by the target retroreflector, then by the mirror, so as to direct the incident laser beam towards the target retroreflector;
determining a virtual position of the target retroreflector, through the mirror;
the device comprises a processing unit configured for
receiving or determining a position and an orientation of the mirror;
determining a real position of the target retroreflector, based on the position of the mirror, on the orientation of the mirror, and on the virtual position of the target retroreflector, after the incident laser beam has been centred relative to the target retroreflector.

2. The device according to claim 1, wherein:
the mirror comprises three auxiliary retroreflectors, defining a plane of the mirror;
the processing unit is configured for
centring the laser emitter successively with respect to each auxiliary retroreflector;
then, determining the position and the orientation of the mirror using each beam respectively reflected by each auxiliary retroreflector.

3. The device according to claim 1, comprising a camera, whose optical axis is parallel to an emission axis of the laser beam, the centring unit being configured for detecting the target retroreflector on each image generated by the camera.

4. The device according to claim 1, wherein:
the mirror is mobile in rotation and/or in translation relative to the laser emitter;
the device comprises a control unit, configured for controlling a rotation of the mirror as a function of a control signal generated by the processing unit.

5. The device according to claim 3, wherein the processing unit is configured for controlling the control unit, so that the target reflector is visible, by the camera, through the mirror.

6. The device according to claim 5, wherein the processing unit is configured for controlling the control unit, so that the target reflector is disposed in the field of observation of the camera, through the mirror.

7. The device according to claim 1, configured so that the incident laser beam extends between the laser emitter and the target retroreflector along a single optical path.

8. A method for determining a position of an object, equipped with a target retroreflector, using a device according to claim 1, the mirror being oriented so that the incident beam, emitted by the laser emitter, circumvents an obstacle extending between the object and the laser emitter, the method comprising:
a) closed-loop controlling a position of the support as a function of the laser beam reflected by the target retroreflector, then by the mirror, so as to centre the incident laser beam with respect to the target retroreflector;
b) following a), determining a position of the target retroreflector as a function of the orientation of the mirror.

9. The method according to claim 8, wherein the mirror comprises at least three non-aligned auxiliary retroreflectors defining a plane of the mirror, the method comprising, prior to a):
centring of the laser emitter successively with respect to each auxiliary retroreflector;
determining a position and orientation of the mirror using each laser beam respectively reflected by each auxiliary retroreflector.

10. The method according to claim 9, wherein
the mirror is mobile in rotation and/or in translation relative to the laser emitter;
the method comprises, prior to a), rotating and/or translating the mirror according to a control signal generated by the processing unit.

11. The method according to claim 10, wherein the mirror is rotated so as to form an image of the target reflector, through the mirror, by the camera.
